(19) United States
(12) Patent Application Publication
(10) Pub. No.: US 2014/0168381 A1
(43) Pub. Date: Jun. 19, 2014

(54) STEREOSCOPIC IMAGE SIGNAL PROCESSING DEVICE AND STEREOSCOPIC IMAGE CAPTURE DEVICE

(71) Applicant: Panasonic Corporation, Osaka (JP)

(72) Inventor: NORIAKI WADA, Hyogo (JP)

(73) Assignee: Panasonic Corporation, Osaka (JP)

(21) Appl. No.: 13/896,743

(22) Filed: May 17, 2013

(30) Foreign Application Priority Data
Dec. 13, 2012 (JP) 2012-271962

(51) Int. Cl. H04N 13/02

(52) U.S. Cl. CPC H04N 13/0246
USPC 348/47

(57) ABSTRACT

This stereoscopic image device includes a parallax converter. The parallax converter sets a first parallax amount of a subject at a specific location on the basis of horizontal field angle information, convergence plane distance information, and inter-axial information. The parallax converter sets a parallax coefficient on the basis of the first parallax amount and a second parallax amount allowed by the subject at a specific location. The parallax converter sets the amount of parallax of the stereoscopic image to be less than or equal to the second parallax amount on the basis of the parallax coefficient.

### CROSS-REFERENCE TO RELATED APPLICATIONS

This application claims priority under 35 U.S.C. §119 to Japanese Patent Application No. 2012-271962 filed on Dec. 13, 2012. The entire disclosure of Japanese Patent Application No. 2012-271962 is hereby incorporated herein by reference.

### BACKGROUND

1. Technical Field

The present disclosure relates to a stereoscopic image signal processing device that changes the amount of parallax of a stereoscopic image made up of a left eye image and a right eye image. This disclosure also relates to a stereoscopic image capture device that captures a stereoscopic image by using a left eye capture component and a right eye capture component, and changes the amount of parallax of this stereoscopic image.

2. Background Information

Devices that capture a stereoscopic image (3D video) by independently and synchronously capturing a left eye image and a right eye image have been garnering attention in recent years. Many different viewing methods and display device display methods have been proposed. These methods are all based on the basic principle that a viewer will be given a stereoscopic impression by the right and left parallax. Parallax corresponds to deviation of the display positions of objects captured in left and right eye images. The magnitude of this deviation is called the amount of parallax.

With a conventional stereoscopic imaging device, it is common to control the angle at which the optical axes of the two imaging components intersect, that is, the convergence angle. Japanese Laid-Open Patent Application 2003-107601 discloses a device in which a stereoscopic image is captured by controlling a left imaging optical system and a right imaging optical system. In Japanese Laid-Open Patent Application 2003-107601, for example, a stereoscopic image is captured by controlling the convergence angle and base line length (inter-axial) of two cameras.

Excessive parallax is a problem when viewing a stereoscopic image captured with a conventional stereoscopic image capture device such as this. For example, if there is too much parallax, the human brain is unable to stereoscopically fuse the images, which makes the image look unnatural. In view of this, the amount of parallax is adjusted by changing the convergence angle, field angle, subject distance, and so forth in capturing the stereoscopic image.

For example, when the field angle changes during capture while zooming with a conventional stereoscopic image capture device, the convergence angle and inter-axial are changed in conjunction with the zoom in order to prevent a major fluctuation in the amount of parallax.

As discussed above, when there is a large amount of parallax in a stereoscopic image, the viewer sees this stereoscopic image as looking unnatural. Therefore, with a conventional stereoscopic image capture device, the convergence angle, field angle, and so forth were adjusted to keep the amount of parallax within the proper range. With this adjustment method, however, if the field angle was small, for example, such as when the zoom lens was used on the telephoto side, a problem was that a large amount of parallax was produced if the subject moved even slightly in the depth direction. Specifically, the problem was that it was difficult to keep the amount of parallax within the proper range.

The principle behind why the amount of parallax increases will now be described, using as an example a case in which the lens is used on the telephoto side.

Guidelines for video producers, related to a stereoscopic image featuring binocular parallax, have been given in “3DC Safety Guidelines for Popularizing User-Friendly 3D,” issued by the 3D Consortium, Apr. 20, 2010 revised edition. According to these guidelines, if we assume that an HD television with an aspect ratio of 16:9 is viewed at a distance that is three times the screen height, the comfortable parallax range is 2.9% or less of the screen width. Specifically, the amount of parallax of an image that pops out toward the viewer must be no more than 2.9% of the screen width, and the amount of parallax of a receding image must be no more than 2.9% of the screen width.

FIG. 4 illustrates the amount of parallax of a pop-out image. In FIGS. 4, 301 and 302 are cameras having zoom lenses, 303 is a convergence plane formed at the position where the optical axis of the camera 301 and the optical axis of the camera 302 intersect, a is the nearest point distance of the comfortable parallax range, c is the convergence plane distance, d is the spacing between the camera 301 and the camera 302 (hereinafter referred to as the inter-axial or base line length; an example of inter-axial information), and ω is the horizontal field angle of the camera 301 and the camera 302 (an example of horizontal field angle information). Here, if an object 304 at the nearest point (hereinafter referred to as the subject) is captured using the two cameras 301 and 302, the straight lines connecting the subject 304 and the cameras 301 and 302 intersect at two points 305 and 304 on a convergence plane 303. The distance e between these two points is the amount of parallax of the stereoscopic image. When the subject 304 is captured at the horizontal field angle ω, the distance f on the convergence plane 303 corresponds to the screen width when the image is displayed.

Because of the above, setting the amount of parallax e of the pop-out image corresponds to setting e÷f to 2.9%. Specifically, this relation is expressed as follows.

e÷f=0.029 (Formula 1)

Here, if we assume the convergence plane distance c to be much greater than the inter-axial d, the distance f is expressed as follows.

$$f \approx 2 \times c \times tan \frac{ω}{2} \qquad ( Formula 2 )$$

Because the relation of two similar triangles gives us the following:

e:c−a=d:a (Formula 3)

the amount of parallax e is expressed as follows.

$$e = \frac{d ( c - a )}{a} \qquad ( Formula 4 )$$

Therefore, the following formula (Formula 5) is derived on the basis of Formulas 1, 2, and 4.

$$0.029 = \frac{d ( c - a )}{a} \times \frac{1}{2 \times c \times tan \frac{ω}{2}} \qquad ( Formula 5 )$$

Specifically, the nearest point distance a is expressed as follows.

$$a = \frac{d \times c}{d + 0.058 \times c \times tan \frac{ω}{2}} \qquad ( Formula 6 )$$

More specifically, the nearest point distance a is found on the basis of the convergence plane distance c, the binocular camera spacing d, and the horizontal field angle ω.

Next, FIG. 5 illustrates the amount of parallax of a receding image. In FIGS. 5, 301 and 302 are cameras having zoom lenses just as in FIG. 4, 303 is a convergence plane formed at the position where the optical axis of the camera 301 and the optical axis of the camera 302 intersect, c is the convergence plane distance, d is the inter-axial, ω is the horizontal field angle of the binocular camera lenses, and b is the farthest point distance in the comfortable parallax range. Here, if an object 401 at the farthest point (hereinafter referred to as the subject) is captured using the two cameras 301 and 302, the straight lines connecting the subject 401 and the cameras 301 and 302 intersect at two points 402 and 403 on a convergence plane 303. The distance g between these two points is the amount of parallax of the stereoscopic image. When the subject 401 is captured at the horizontal field angle ω, the distance f on the convergence plane 303 corresponds to the screen width when the image is displayed.

Because of the above, setting the amount of parallax g of the receding image corresponds to setting g÷f to 2.9%. Specifically, this relation is expressed as follows.

g÷f=0.029 (Formula 7)

Here, if we assume the convergence plane distance c to be much greater than the inter-axial d, the distance f is expressed as follows, just as in FIG. 4.

$$f \approx 2 \times c \times tan \frac{ω}{2} \qquad ( Formula 2 )$$

Because the relation of two similar triangles gives us the following:

b−c:g=b:d (Formula 8)

the amount of parallax g is expressed as follows.

$$g = \frac{d ( b - c )}{b} \qquad ( Formula 9 )$$

Therefore, the following formula (Formula 10) is derived on the basis of Formulas 1, 2, and 9.

$$0.029 = \frac{d ( b - c )}{b} \times \frac{1}{2 \times c \times tan \frac{ω}{2}} \qquad ( Formula 10 )$$

Specifically, the farthest point distance b is expressed as follows.

$$b = \frac{d \times c}{d - 0.058 \times c \times tan \frac{ω}{2}} \qquad ( Formula 11 )$$

More specifically, the farthest point distance b is found on the basis of the convergence plane distance c, the binocular camera spacing d, and the horizontal field angle ω.

In Formulas 6 and 11, if the horizontal field angle ω decreases (if the zoom lens is moved to the telephoto side), the value of a increases and the value of b decreases. For example, if c=7.00 m and d=0.065 m, when w is changed from 12° to 2°, if ω=12° then a=4.2 m and b=20.4 m, and if ω=2° C. then a=6.3 m and b=7.9 m. Specifically, as w decreases, the value of increases and the value of b decreases.

More specifically, when ω is 12° (when w is large), the subject distance range for achieving a comfortable parallax (hereinafter referred to as the comfortable parallax range) is from 4.2 m to 20.4 m. On the other hand, when ω is 2° (when w is small; when the lens is set to telephoto), the comfortable parallax range is from 6.3 m to 7.9 m. Specifically, as w decreases, the comfortable parallax range narrows.

When the horizontal field angle ω is set to be small, the comfortable parallax range becomes even narrower. The fact that the comfortable parallax range becomes narrower means that a large parallax has been generated by a slight change in distance. Specifically, excessive parallax tends to occur when a stereoscopic image is actually captured. For example, even if the convergence plane is set for the target subject, and the parallax is set to the comfortable parallax range, there is the risk that the comfortable parallax range may be exceeded by some other subject or the like located in front of the target subject, or by landscape behind the target subject.

Specifically, it was difficult with prior art to keep the amount of parallax within the proper range when the lens was used on the telephoto side, for example. This disclosure was conceived in light of this problem, and it is an object of this disclosure to provide a stereoscopic imaging device and a stereoscopic image signal processing device configured so that the parallax of the stereoscopic image is controlled so as not to exceed the comfortable parallax range.

### SUMMARY

The stereoscopic image signal processing device disclosed herein is configured to produce a stereoscopic image made up of a left eye image and a right eye image. This stereoscopic image signal processing device comprises a parallax converter. The parallax converter is configured to set a first parallax amount for a subject at a specific location on the basis of horizontal field angle information, convergence plane distance information, and inter-axial information. The parallax converter also is configured to set a parallax coefficient on the basis of the first parallax amount and a second parallax amount allowed for a subject in the specific location. The parallax converter further is configured to set the amount of parallax in the stereoscopic image to be less than or equal to the second parallax amount on the basis of the parallax coefficient.

The stereoscopic image capture device disclosed herein comprises a left eye image capture component, a right eye image capture component, a field angle controller, a convergence angle controller, a base line length controller, and a parallax converter. The left eye image capture component includes a first zoom lens and is configured to capture a left eye image. The right eye image capture component includes a zoom lens and is configured to capture a right eye image. The field angle controller is configured to control a field angle of the first zoom lens and a field angle of the second zoom lens, and output horizontal field angle information. The convergence angle controller is configured to control a convergence angle of the left eye image capture component and a convergence angle of the right eye image capture component, and output convergence angle information. The base line length controller is configured to control a base line length between the left eye image capture component and the right eye image capture component, and output inter-axial information. The parallax converter is configured to convert the amount of parallax of a stereoscopic image made up of a left eye image and a right eye image on the basis of the horizontal field angle information, the convergence angle information, and the inter-axial information.

The parallax converter sets a first parallax amount of a subject at a specific location on the basis of the horizontal field angle information, the convergence angle information, and the inter-axial information. The parallax converter also sets a parallax coefficient on the basis of the first parallax amount and a second parallax amount allowed for a subject in the specific location. The parallax converter further sets the amount of parallax in the stereoscopic image to be less than or equal to the second parallax amount on the basis of the parallax coefficient.

The stereoscopic image capture device disclosed herein comprises a left eye image capture component, a right eye image capture component, a field angle controller, a convergence angle controller, and a parallax converter. The left eye image capture component includes a first zoom lens and is configured to capture a left eye image. The right eye image capture component includes a second zoom lens and is configured to capture a right eye image. The field angle controller is configured to control a field angle of the first zoom lens and a field angle of the second zoom lens, and output horizontal field angle information.

The convergence angle controller is configured to control a convergence angle of the left eye image capture component and a convergence angle of the right eye image capture component, and output convergence angle information. The parallax converter is configured to change the amount of parallax of a stereoscopic image made up of a left eye image and a right eye image on the basis of horizontal field angle information, convergence angle information, and inter-axial information. The inter-axial information includes a base line length between the left eye image capture component and the right eye image capture component in a state in which the base line length is fixed.

The parallax converter sets a first parallax amount of a subject at a specific location on the basis of horizontal field angle information, convergence angle information, and inter-axial information. The parallax converter also sets a parallax coefficient on the basis of the first parallax amount and a second parallax amount allowed for a subject in the specific location. The parallax converter further sets the amount of parallax in the stereoscopic image to be less than or equal to the second parallax amount on the basis of the parallax coefficient.

With the stereoscopic imaging device and stereoscopic video signal processing device disclosed herein, the parallax of a stereoscopic image is controlled so as not to exceed the comfortable parallax range, which allows a good stereoscopic image to be provided. For example, the parallax of a stereoscopic image can be set within the comfortable parallax range in this disclosure even when a stereoscopic image with a small field angle is inputted to the stereoscopic video signal processing device, or when the field angle is set small by manipulation of the zoom lens on the stereoscopic image capture device. Specifically, this disclosure provides a stereoscopic image that can be viewed comfortably.

### BRIEF DESCRIPTION OF THE DRAWINGS

Referring now to the attached drawings, which form a part of this original disclosure:

FIG. 1 is a block diagram of the configuration of the stereoscopic image signal processing device in Embodiment 1;

FIG. 2 is a block diagram of the configuration of the stereoscopic image capture device in Embodiment 2;

FIG. 3 is a block diagram of the configuration of the stereoscopic image capture device in Embodiment 3;

FIG. 4 is a diagram illustrating the parallax of a pop-out image; and

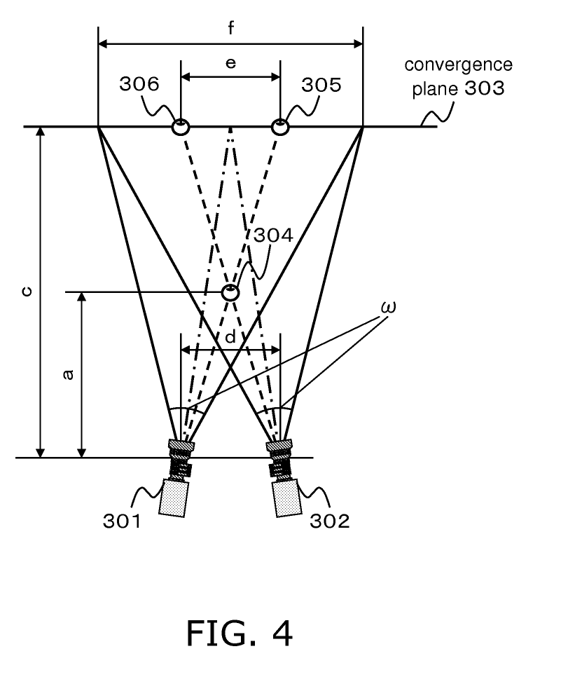

FIG. 5 is a diagram illustrating the parallax of a receding image.

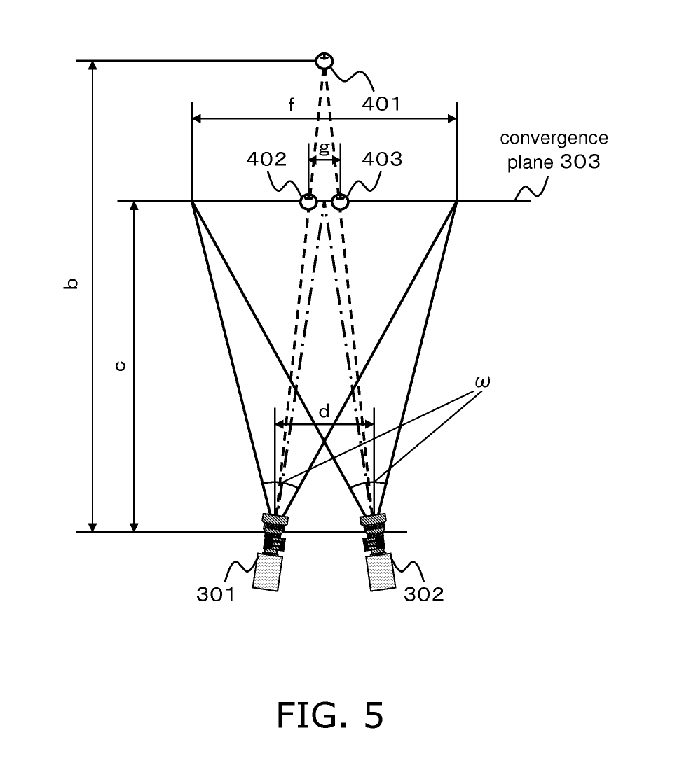

### DETAILED DESCRIPTION OF EMBODIMENTS

Selected embodiments of the present technology will now be explained with reference to the drawings. It will be apparent to those skilled in the art from this disclosure that the following descriptions of the embodiments of the present technology are provided for illustration only and not for the purpose of limiting the technology as defined by the appended claims and their equivalents. The stereoscopic image signal processing device and stereoscopic image capture device in these embodiments will now be described in detail through reference to the drawings.

### First Embodiment

### 1. Configuration of Stereoscopic Image Signal Processing Device

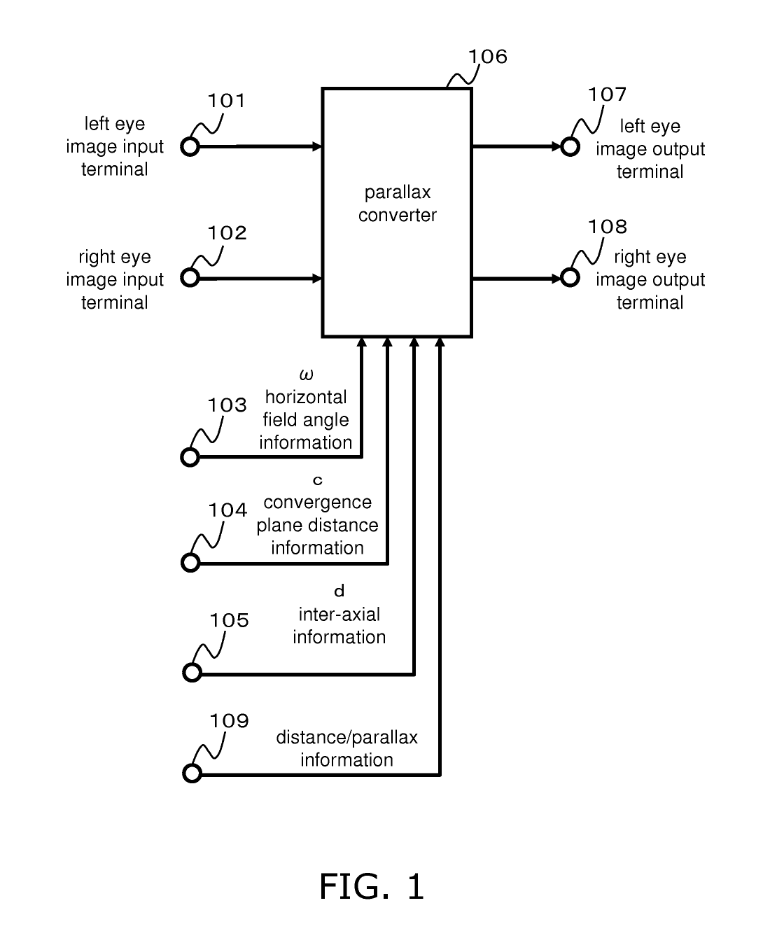

FIG. 1 is a block diagram of the configuration of the stereoscopic image signal processing device in Embodiment 1. In FIG. 1, 106 is a parallax converter. The parallax converter 106 executes computation processing on the basis of a left eye image signal, a right eye image signal, a horizontal field angle ω (degrees), a convergence plane distance c (meters), a inter-axial d (meters), and distance/parallax information, and outputs a left eye image and right eye image that have undergone computation processing to a left eye image output terminal 107 and a right eye image output terminal 108.

The left eye image signal is inputted from a left eye image input terminal 101 to the parallax converter 106. The right eye image signal is inputted from a right eye image input terminal 102 to the parallax converter 106. The left eye image signal inputted from the left eye image input terminal 101 to the parallax converter 106, and the right eye image signal inputted from the right eye image input terminal 102 to the parallax converter 106 are image signals with an aspect ratio of 16:9, an effective horizontal pixel count of 1920, and an effective vertical pixel count of 1080.

The horizontal field angle ω (degrees) is inputted from a horizontal field angle input terminal 103 to the parallax converter 106. The convergence plane distance c (meters) is inputted from a convergence plane distance input terminal 104 to the parallax converter 106. The inter-axial d (meters) is inputted from a inter-axial input terminal 105 to the parallax converter 106. The inter-axial d (meters) is an example of inter-axial information. The distance/parallax information is inputted from a setting terminal 109 to the parallax converter 106. This distance/parallax information is used to set the amount of parallax at a specific distance.

### 2. Operation of Stereoscopic Image Signal Processing Device

The operation of the stereoscopic image signal processing device configured as above will now be described. First, distance information and information about the amount of parallax are inputted from the setting terminal 109 to the parallax converter 106. For example, a distance of 30 m and a parallax of 2% are inputted. These are the conditions for setting the amount of parallax on the depth side of a subject at a distance of 30 m (an example of the allowable amount of parallax) to 2% of the screen width. These conditions assume that the distance to the subject farthest from the cameras (hereinafter referred to as the farthest subject) is 30 m and the amount of parallax on the depth side of the farthest subject is 2%, in normal indoor imaging, etc. In this case, the convergence plane distance c is set to a value that is less than 30 m.

Here, the amount of parallax x of the subject located at a distance of 30 m (an example of the first parallax amount) is found from the following formula. Here, the amount of parallax x is defined as the ratio of parallax to screen width.

$$x = \frac{d \times ( 30 - c )}{2 \times 30 \times c \times tan \frac{ω}{2}} = \frac{d \times ( 30 - c )}{60 \times c \times tan \frac{ω}{2}} \qquad ( Formula 12 )$$

A parallax coefficient Q (Q is a positive real number) for setting the amount of parallax allowed by the farthest subject (the allowable amount of parallax, the amount of parallax on the depth side; an example of a second parallax amount) to 2% is found from the following formula.

$$Q = \frac{x}{0.02} = \frac{d \times ( 30 - c )}{0.02 \times 60 \times c \times tan \frac{ω}{2}} \qquad ( Formula 13 )$$

Next, this parallax coefficient Q is used by the parallax converter 106 to execute parallax conversion computation. The parallax converter 106 extracts a contour on the basis of the left eye image signal and the right eye image signal taken from the left eye image input terminal 101 and the right eye image input terminal 102. There are many different methods for extracting a contour. In this embodiment, for example, the parallax converter 106 determines a contour by scanning brightness changes over a given line in the horizontal direction. More specifically, the parallax converter 106 determines the portion of a 10-bit 1024 gradation in which there is a brightness change of at least 16 shades.

The parallax converter 106 first detects the contour of the left eye image, and then detects the contour of the right eye image corresponding to the contour of the left eye image. The contour of the right eye image is detected as follows. In a right eye image that lies on the same scanning line as the contour extracted from the left eye image, the contour of the right eye image is detected within a range of 128 pixels in the horizontal direction, using as a reference the position corresponding to the detected contour of the left eye image. More specifically, the portion where a change (an increase or decrease) in the brightness of the right eye image exhibits the same pattern as in the left eye image is detected as the contour of the right eye image.

The contour of the right eye image is determined by whether or not the pattern of change in the brightness level matches that of the contour of the left eye image, and whether or not the number of shades of the brightness change matches that of the contour of the left eye image.

For example, if the pattern of increase of the brightness level when the right eye image is scanned from the left to the right of the screen, and the pattern of decrease of the brightness level when this is done match the increasing and decreasing patterns of the brightness level of the left eye image, then it is determined that the portion where the change patterns match is the contour of the right eye image corresponding to the contour of the left eye image. Also, if the number of shades of the brightness change in the right eye image is within ±30% of the number of shades of the brightness change in the left eye image, the portion included in this range is determined to be the contour of the right eye image corresponding to the contour of the left eye image.

When the parallax converter 106 thus detects the contour of the left eye image and the contour of the right eye image, it calculates the amount of deviation in the horizontal direction between the two contours (corresponds to the amount of parallax), such as the number of pixels.

Then, the parallax converter 106 moves the contour of the right eye image locally in the horizontal direction so that this deviation becomes 1/Q. For example, in a state in which a certain horizontal field angle, a certain inter-axial, and a certain convergence plane distance have been set, if the amount of parallax x of a subject at a distance of 30 m is 4%, and if the amount of parallax on the depth side (the allowable amount of parallax) is set to 2%, then the parallax coefficient Q is 2. In this case, the parallax converter 106 converts the amount of parallax between the contour of the left eye image and the contour of the right eye image (an example of a third parallax amount) overall to ½ (=1/Q). In other words, the parallax converter 106 locally shifts the left eye image so that the amount of parallax between the contour of the left eye image and the contour of the right eye image drops to one-half overall. For example, if a certain contour includes a parallax of 60 pixels (approximately 3.1% of the screen width), then this contour is converted into a parallax of 30 pixels (approximately 1.6% of the screen width).

### 3. Conclusion

With the stereoscopic image signal processing device pertaining to Embodiment 1, the parallax coefficient Q is found by inputting the allowable value for the amount of parallax of a subject at a specific distance. The amount of parallax can be kept at or under the allowable amount of parallax by setting the overall amount of parallax between the left eye image and right eye image to 1/Q. Specifically, a stereoscopic image having good parallax can be produced.

Also, with the stereoscopic image signal processing device pertaining to Embodiment 1, the amount of parallax between the left eye image and right eye image can be kept at or under the allowable amount of parallax overall in a state in which the amount of parallax of the convergence plane is maintained, without partially keeping the amount at or under the allowable amount of parallax. Specifically, with the stereoscopic image signal processing device pertaining to Embodiment 1, a state in which the amount of parallax of a subject in the convergence plane is zero can be maintained, while the overall amount of parallax is kept at or under the allowable amount. This prevents an imbalance in the image that can be caused by adjustment of the amount of parallax.

### Second Embodiment

### 1. Configuration of Stereoscopic Image Capture Device

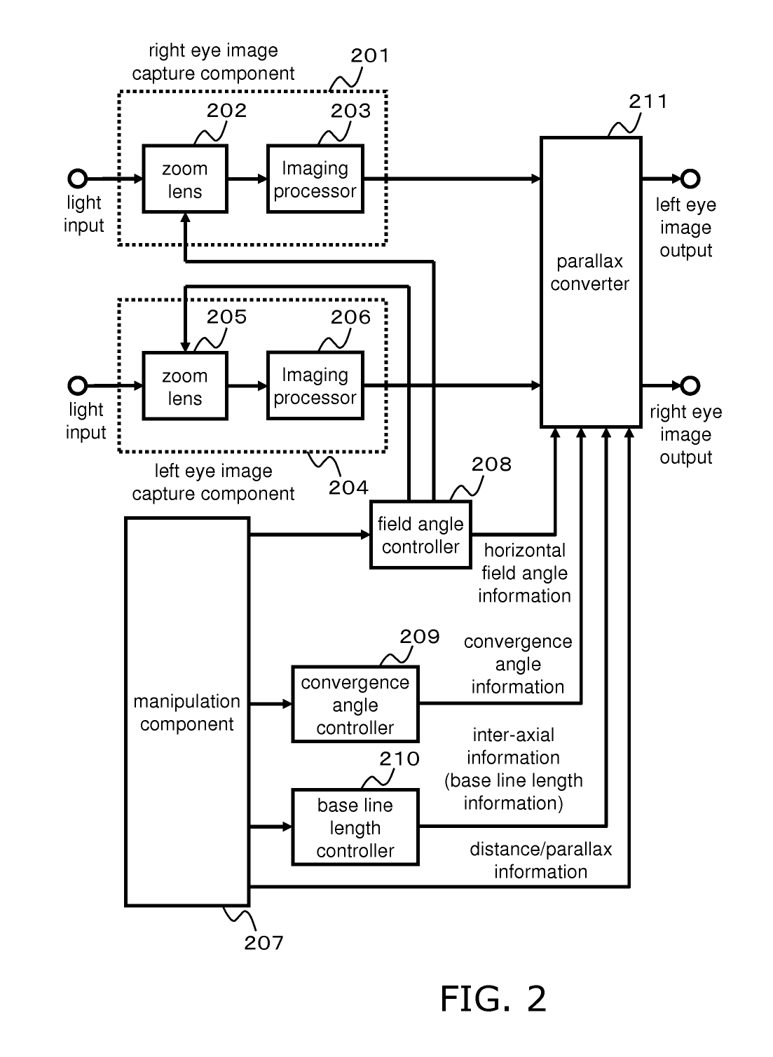

FIG. 2 is a block diagram of the configuration of the stereoscopic image capture device in Embodiment 2. In FIG. 2, 201 is a right eye image capture component, 204 is a left eye image capture component, 202 and 205 are zoom lenses, 203 and 206 are imaging processors, 207 is a manipulation component, 208 is a field angle controller, 209 is a convergence angle controller, 210 is a base line length controller, and 211 is a parallax converter.

The right eye image capture component 201 and the left eye image capture component 204 capture images via the zoom lenses 202 and 205 through optical input, and output image signals with an aspect ratio of 16:9, an effective horizontal pixel count of 1920, and an effective vertical pixel count of 1080.

The field angles of the zoom lenses, the convergence angle of the binocular stereoscopic image (an example of convergence angle information), the base line length of the binocular stereoscopic image (inter-axial), and the upper limit to which the amount of parallax is controlled (the allowable amount of parallax) are inputted to the manipulation component 207. The field angle controller 208 controls the field angles of the zoom lenses 202 and 205 on the basis of these inputs. The field angle controller 208 also outputs horizontal field angle information to the parallax converter 211.

The convergence angle controller 209 changes the convergence angle formed by the optical axis of the right eye image capture component 201 and the optical axis of the left eye image capture component 204. The convergence angle controller 209 also outputs convergence angle information to the parallax converter 211.

The base line length controller 210 changes the base line length of the right eye image capture component 201 and the base line length of the left eye image capture component 204. The base line length controller 210 also outputs information corresponding to the base line length, namely, inter-axial information, to the parallax converter 211.

### 2. Operation of Stereoscopic Image Capture Device

The operation of the stereoscopic image capture device configured as above will now be described.

The field angle controller 208 controls the field angles of the zoom lenses 202 and 205 according to the input to the manipulation component 207. For instance, the field angle controller 208 controls the zoom lenses 202 and 205 so that the field angle of the left eye image will be the same as the field angle of the right eye image. The field angle controller 208 also outputs horizontal field angle information to the parallax converter 211.

The convergence angle controller 209 changes the imaging optical axis of the right eye image capture component 201 and the imaging optical axis of the left eye image capture component 204 according to the input to the manipulation component 207. Thus, the convergence angle is changed on the basis of input to the manipulation component 207. The convergence angle information includes the convergence angle and is outputted to the parallax converter 211.

The base line length controller 210 changes the base line length of the right eye image capture component 201 and the base line length of the left eye image capture component 204 according to the input to the manipulation component 207. For instance, the base line length controller 210 changes the base line length of the right eye image capture component 201 and the base line length of the left eye image capture component 204 within a range of from 60 mm to 120 mm, for example. Thus, the base line length is changed on the basis of the input to the manipulation component 207. The base line length controller 210 also outputs inter-axial information (information corresponding to the base line length) to the parallax converter 211.

Distance/parallax information is inputted to the manipulation component 207. For instance, when information indicating a distance of 30 m and an amount of parallax of 2% is inputted to the manipulation component 207, the amount of parallax on the depth side of a subject at a distance of 30 m (the allowable amount of parallax) is set to 2% of the screen width. The parallax converter 211 computes a parallax coefficient R (R is a positive real number) on the basis of these conditions. In Embodiment 2, the parallax coefficient is labeled “R” in order to differentiate it from Embodiment 1. The parallax coefficient R in Embodiment 2 is calculated from Formula 13, just as is the parallax coefficient Q in Embodiment 1.

The parallax converter 211 operates the same as the parallax converter 106 described in Embodiment 1, and will therefore not be described again in detail here. Specifically, refer to the description in Embodiment 1 for the description omitted here. The parallax converter 211 converts the amount of parallax between the contour of the inputted left eye image and the contour of the right eye image (an example of a third parallax amount) to 1/R, and outputs the result.

### Conclusion

With the stereoscopic image capture device pertaining to Embodiment 2, the parallax coefficient R is found by inputting and setting the allowable amount of parallax for a subject at a specific distance. The amount of parallax can be kept at or under the allowable amount of parallax by setting the amount of parallax between the left eye image and right eye image to 1/R overall. Specifically, a stereoscopic image having good parallax can be produced.

Also, with the stereoscopic image capture device pertaining to Embodiment 2, the amount of parallax between the left eye image and right eye image can be kept at or under the allowable amount of parallax overall in a state in which the amount of parallax of the convergence plane is maintained, without partially keeping the amount at or under the allowable amount of parallax. Specifically, with the stereoscopic image capture device pertaining to Embodiment 2, a state in which the amount of parallax of a subject in the convergence plane is zero can be maintained, while the overall amount of parallax is kept at or under the allowable amount. This prevents an imbalance in the image that can be caused by adjustment of the amount of parallax.

### Third Embodiment

### 1. Configuration of Stereoscopic Image Capture Device

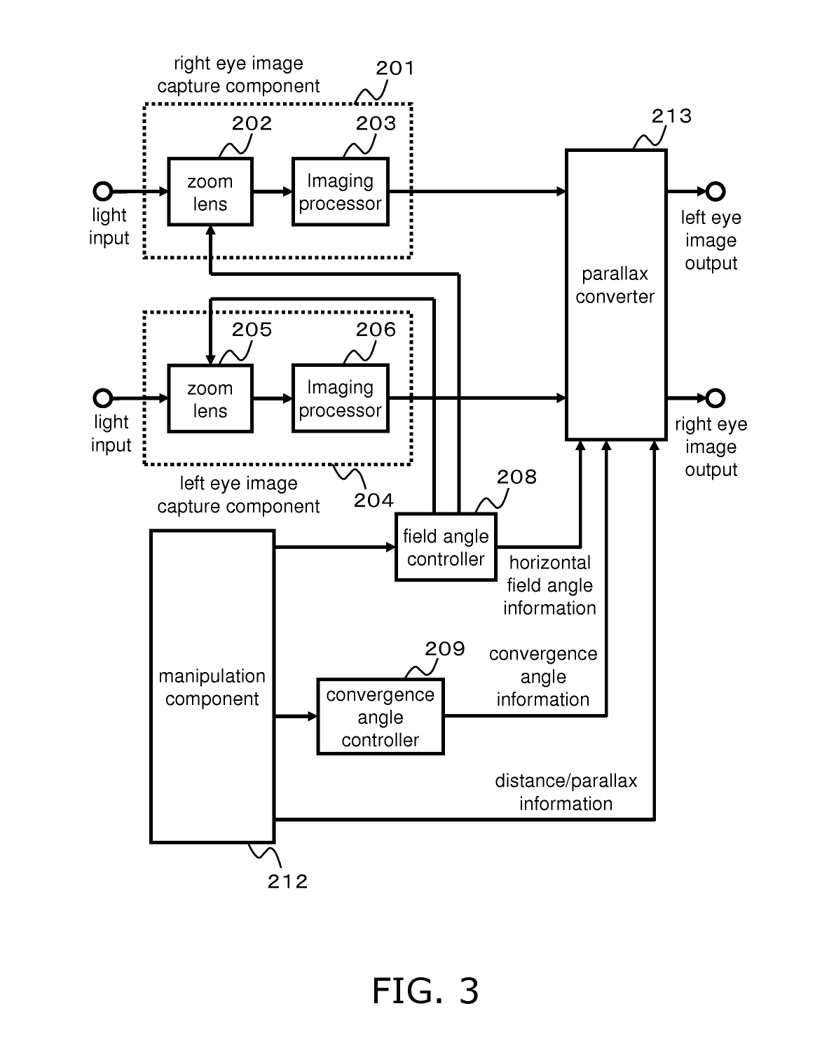

FIG. 3 is a block diagram of the configuration of the stereoscopic image capture device in Embodiment 3. In FIG. 3, 201 is a right eye image capture component, 204 is a left eye image capture component, 202 and 205 are zoom lenses, 203 and 206 are imaging processors, 212 is a manipulation component, 208 is a field angle controller, 209 is a convergence angle controller, and 213 is a parallax converter.

The right eye image capture component 201 and the left eye image capture component 204 capture images via the zoom lenses 202 and 205 through optical input, and output image signals with an aspect ratio of 16:9, an effective horizontal pixel count of 1920, and an effective vertical pixel count of 1080.

The field angles of the zoom lenses, the convergence angle of the binocular stereoscopic image, the specific distance, and the upper limit to which the amount of parallax is controlled (the allowable amount of parallax) are inputted to the manipulation component 212. The field angle controller 208 controls the field angles of the zoom lenses 202 and 205 on the basis of these inputs. The field angle controller 208 also outputs horizontal field angle information to the parallax converter 211.

The convergence angle controller 209 changes the convergence angle formed by the optical axis of the right eye image capture component 201 and the optical axis of the left eye image capture component 204 (an example of convergence angle information). The convergence angle controller 209 also outputs convergence angle information to the parallax converter 211.

In Embodiment 3, the base line length (an example of inter-axial information) is fixed. The inter-axial is set to 60 mm, for example.

### 2. Operation of Stereoscopic Image Capture Device

The operation of the stereoscopic image capture device configured as above will now be described.

The field angle controller 208 controls the field angles of the zoom lenses 202 and 205 according to the input to the manipulation component 212. For instance, the field angle controller 208 controls the zoom lenses 202 and 205 so that the field angle of the left eye image will be the same as the field angle of the right eye image. The field angle controller 208 also outputs horizontal field angle information to the parallax converter 211. For example, the convergence angle controller 209 controls the zoom lenses 202 and 205 so that the field angle of the left eye image will be the same as the field angle of the right eye image. The field angle controller 208 also outputs horizontal field angle information to the parallax converter 211.

The convergence angle controller 209 changes the imaging optical axis of the right eye image capture component 201 and the imaging optical axis of the left eye image capture component 204 according to the input to the manipulation component 212. This changes the convergence angle. Thus, the convergence angle is changed on the basis of input to the manipulation component 212. The convergence angle information includes the convergence angle and is outputted to the parallax converter 213.

Distance/parallax information is inputted to the manipulation component 212. For instance, when information indicating a distance of 30 m and an amount of parallax of 2% is inputted to the manipulation component 212, the amount of parallax on the depth side of a subject at a distance of 30 m (the allowable amount of parallax) is set to 2% of the screen width. The parallax converter 213 computes a parallax coefficient S (S is a positive real number) on the basis of these conditions. In Embodiment 3, the parallax coefficient is labeled “S” in order to differentiate it from Embodiments 1 and 2. The parallax coefficient S in Embodiment 3 is calculated from Formula 13, just as is the parallax coefficient Q in Embodiment 1.

The parallax converter 213 operates the same as the parallax converter 106 described in Embodiment 1, and will therefore not be described again in detail here. Specifically, refer to the description in Embodiment 1 for the description omitted here. The parallax converter 213 converts the amount of parallax between the contour of the inputted left eye image and the contour of the right eye image (an example of a third parallax amount) to 1/S, and outputs the result.

### Conclusion

With the stereoscopic image capture device pertaining to Embodiment 3, the parallax coefficient S is found by inputting and setting the allowable amount of parallax for a subject at a specific distance. The amount of parallax can be kept at or under the allowable amount of parallax by setting the amount of parallax between the left eye image and right eye image to 1/S overall. Specifically, a stereoscopic image having good parallax can be produced.

Also, with the stereoscopic image capture device pertaining to Embodiment 3, the amount of parallax between the left eye image and right eye image can be kept at or under the allowable amount of parallax overall in a state in which the amount of parallax of the convergence plane is maintained, without partially keeping the amount at or under the allowable amount of parallax. Specifically, with the stereoscopic image capture device pertaining to Embodiment 3, a state in which the amount of parallax of a subject in the convergence plane is zero can be maintained, while the overall amount of parallax is kept at or under the allowable amount. This prevents an imbalance in the image that can be caused by adjustment of the amount of parallax.

### Other Embodiments

Embodiments were described above as examples of the technology disclosed herein, and the appended drawings and detailed description were provided for this purpose.

Therefore, the constituent elements discussed in the appended drawings and detailed description may encompass not just those constituent elements that are essential to solving the problem, but also constituent elements that are not essential to solving the problem. Accordingly, just because these non-essential constituent elements are discussed in the appended drawings and detailed description, that should not necessarily lead to the conclusion that the non-essential constituent elements are essential.

Also, the above embodiments were given to illustrate examples of the technology disclosed herein, so various modifications, substitutions, additions, omissions, and so forth can be made within the scope of the patent claims or equivalents thereof.

Examples of other embodiments of this disclosure are compiled below. As discussed above, this disclosure is not limited to or by these embodiments, and can also be applied to suitably modified embodiments.

(A) In Embodiment 1, an example was given in which the allowable amount of parallax at a specific distance (maximum amount of parallax) was specified by inputting distance information and parallax information to the setting terminal 109 in the stereoscopic image signal processing device shown in FIG. 1, but the parallax coefficient Q may be found by using a preset allowable amount of parallax at a specific distance, without any input to the setting terminal 109. For example, the parallax coefficient Q may be found by using the allowable amount of parallax for an object at infinity.

(B) In Embodiment 1, an example was given in which the allowable amount of parallax at a specific distance was specified by inputting distance information and parallax information to the manipulation component 207 in the stereoscopic image capture device shown in FIG. 2, but the parallax coefficient R may be found by using a preset allowable amount of parallax at a specific distance, without any input to the manipulation component 207. For example, the parallax coefficient R may be found by using the allowable amount of parallax for an object at infinity.

(C) In Embodiment 1, an example was given in which the allowable amount of parallax at a specific distance was specified by inputting distance information and parallax information to the manipulation component 212 in the stereoscopic image capture device shown in FIG. 3, but the parallax coefficient S may be found by using a preset allowable amount of parallax at a specific distance, without any input to the manipulation component 212. For example, the parallax coefficient S may be found by using the allowable amount of parallax for an object at infinity.

As discussed above, the amount of parallax can be kept at or under the allowable amount by finding the parallax coefficients Q, R, and S, without taking the subject distance into account. For example, the allowable amount of parallax at a specific distance can be specified when the distance of the farthest object (the farthest subject) is certain, such as in indoor imaging and/or imaging when there is a wall behind the subject. However, even in a case such as this, if the landscape outside a window is photographed, or clouds in the sky are photographed, there is the risk that the distance to the farthest object will be uncertain, or the distance to the farthest object cannot be measured. In this case, it will be difficult to specify a specific distance for setting the allowable amount of parallax. However, if the allowable amount of parallax at infinity is specified, then there will be no need to measure and/or calculate the distance to the farthest object.

(D) In Embodiments 1 to 3, an example was given in which the contour was determined by scanning the brightness change along the same line in the horizontal direction. Instead, it may be determined by using two-dimensional (horizontal and vertical) information and/or an RGB signal.

(E) In Embodiments 1 to 3, an example was given in which the amount of parallax of a contour was calculated on the same line in the horizontal scanning direction, but the brightness change may be scanned on a plurality of the same lines in the horizontal direction that are included in a specific range of the vertical direction. For example, deviation in the horizontal direction may be calculated by expanding the scanning range to adjacent lines above and below the scanning line in the above embodiments. In this case, the amount of parallax can be correctly measured even though the pattern of a given contour of a binocular image deviates in the vertical direction of the screen rather than the horizontal direction.

(F) In Embodiments 1 to 3, an example was given in which the amount of parallax (amount of deviation) between the contour of the left eye image and the contour of the right eye image on the same line in the horizontal direction was calculated on the basis of the pixel count. Instead, the amount of parallax may be calculated using two-dimensional (horizontal and vertical) information and/or an RGB signal.

(G) In Embodiments 1 to 3, an example was given in which the value of the horizontal field angle ω included in the horizontal field angle information was inputted to the parallax converter. Instead, a value that can be converted into the horizontal field angle may be inputted as horizontal field angle information to the parallax converter. Values that can be converted into a horizontal field angle include the focal distance of the zoom lens and/or a value indicating the position of the zoom lens.

(H) The content of Embodiments 1 to 3 can be expressed as follows.

(H-1) The stereoscopic image signal processing device disclosed herein is a stereoscopic image signal processing device that produces a stereoscopic image made up of a left eye image and a right eye image, the device comprising a parallax converter that changes the amount of parallax of the stereoscopic image on the basis of horizontal field angle information, convergence plane distance information, and inter-axial information during the capture of the stereoscopic image. This parallax converter finds the screen width ratio of the amount of parallax of a subject at a specific distance, which is found from horizontal field angle information, convergence plane distance information, and inter-axial information. This parallax converter finds a parallax coefficient Q (Q is a positive real number) that is the ratio between the screen width ratio and the predetermined setting for amount of parallax. This parallax converter also detects contours from the inputted left eye image and right eye image, converts into an amount of parallax such that the amount of parallax of the detected contours is 1/Q, and outputs the resulting left eye image and right eye image.

(H-2) With the stereoscopic image signal processing device disclosed herein, the predetermined setting for amount of parallax shall be the amount of parallax of a subject corresponding to infinity.

(H-3) The stereoscopic image capture device disclosed herein comprises a left eye image capture component that includes a zoom lens and captures a left eye image, a right eye image capture component that includes a zoom lens and captures a right eye image, a field angle controller that controls the field angle of the zoom lens of the left eye image capture component and the field angle of the zoom lens of the right eye image capture component, and outputs horizontal field angle information that includes these field angles, a convergence angle controller that controls the convergence angles of the left eye image capture component and the right eye image capture component and outputs convergence angle information, a base line length controller that controls the base line length of the left eye image capture component and the right eye image capture component, and outputs inter-axial information, and a parallax converter that changes the amount of parallax of a stereoscopic image made up of a left eye image and a right eye image on the basis of horizontal field angle information, convergence angle information, and inter-axial information. The parallax converter finds the screen width ratio of the amount of parallax of a subject at a specific distance that is found from horizontal field angle information, convergence angle information, and inter-axial information. This parallax converter finds a parallax coefficient R (R is a positive real number) that is the ratio between the screen width ratio and the predetermined setting for amount of parallax. This parallax converter also detects contours from the inputted left eye image and right eye image, converts into an amount of parallax such that the amount of parallax of the detected contours is 1/R, and outputs the resulting left eye image and right eye image.

(H-4) With the stereoscopic image capture device disclosed herein, the predetermined setting for amount of parallax shall be the amount of parallax of a subject corresponding to infinity.

(H-5) The stereoscopic image capture device disclosed herein comprises a left eye image capture component that includes a zoom lens and captures a left eye image, a right eye image capture component that includes a zoom lens and captures a right eye image, a field angle controller that controls the field angle of the zoom lens of the left eye image capture component and the field angle of the zoom lens of the right eye image capture component, and outputs horizontal field angle information that includes these field angles, a convergence angle controller that controls the convergence angles of the left eye image capture component and the right eye image capture component and outputs convergence angle information, and a parallax converter that fixes the base line length of the left eye image capture component and the right eye image capture component and changes the amount of parallax of a stereoscopic image made up of a left eye image and a right eye image on the basis of fixed values for horizontal field angle information, convergence angle information, and inter-axial information. The parallax converter finds the screen width ratio of the amount of parallax of a subject at a specific distance that is found from horizontal field angle information, convergence angle information, and inter-axial information. This parallax converter finds a parallax coefficient R (R is a positive real number) that is the ratio between the screen width ratio and the predetermined setting for amount of parallax. This parallax converter also detects contours from the inputted left eye image and right eye image, converts into an amount of parallax such that the amount of parallax of the detected contours is 1/R, and outputs the resulting left eye image and right eye image.

(H-6) With the stereoscopic image capture device disclosed herein, the predetermined setting for amount of parallax shall be the amount of parallax of a subject corresponding to infinity.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the stereoscopic image signal processing device and the stereoscopic image capture device. Accordingly, these terms, as utilized to describe the present technology should be interpreted relative to the stereoscopic image signal processing device and the stereoscopic image capture device.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the present technology, it will be apparent to those skilled in the art from this disclosure that various changes and modifications can be made herein without departing from the scope of the technology as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further technologies by the applicant, including the structural and/or functional concepts embodied by such feature(s). Thus, the foregoing descriptions of the embodiments according to the present technologies are provided for illustration only, and not for the purpose of limiting the technology as defined by the appended claims and their equivalents.

### INDUSTRIAL APPLICABILITY

The stereoscopic image signal processing device and stereoscopic imaging device disclosed herein provide a good stereoscopic image by controlling the parallax of the stereoscopic image so as not to exceed the comfortable parallax range. The stereoscopic image signal processing device and stereoscopic imaging device disclosed herein can be applied to stereoscopic imaging and production for use in broadcast and commercial fields, and to consumer-use stereoscopic imaging and production. In particular, these are extremely useful in sporting events and the like in which the images are captured in telephoto mode, and in outdoor imaging that combines close-up subjects with distant backgrounds.

What is claimed is:

1. A stereoscopic image signal processing device configured to produce a stereoscopic image, the stereoscopic image made up of a left eye image and a right eye image, the stereoscopic image signal processing device comprising:
a parallax converter configured to set a first parallax amount for a subject at a specific location on a basis of horizontal field angle information, convergence plane distance information, and inter-axial information, set a parallax coefficient on a basis of the first parallax amount and a second parallax amount allowed for a subject in the specific location, and set an amount of parallax in the stereoscopic image to be less than or equal to the second parallax amount on a basis of the parallax coefficient.

2. The stereoscopic image signal processing device according to claim 1, wherein
the parallax coefficient is a ratio of the second parallax amount with respect to the first parallax amount.

3. The stereoscopic image signal processing device according to claim 1, wherein
the parallax converter sets the amount of parallax of the stereoscopic image to be less than or equal to the second parallax amount by detecting a first contour of the left eye image and a second contour of the right eye image, and converting a third parallax amount between the first contour and the second contour so that the third parallax amount is an inverse multiple of the parallax coefficient.

4. The stereoscopic image signal processing device according to claim 1, wherein
the first parallax amount and the second parallax amount are set for a subject located at an infinite distance.

5. A stereoscopic image capture device, comprising:
a left eye image capture component including a first zoom lens and configured to capture a left eye image;
a right eye image capture component including a second zoom lens and configured to capture a right eye image;
a field angle controller configured to control a field angle of the first zoom lens and a field angle of the second zoom lens and output horizontal field angle information, the horizontal field angle information including the field angles of the first zoom lens and second zoom lens;
a convergence angle controller configured to control a convergence angle of the left eye image capture component and a convergence angle of the right eye image capture component, and output convergence angle information, the convergence angle information including the convergence angles of the left eye image capture component and the right eye image capture component;
a base line length controller configured to control a base line length between the left eye image capture component and the right eye image capture component and output inter-axial information, the inter-axial information including the base line length; and
a parallax converter configured to change an amount of parallax of a stereoscopic image on a basis of the horizontal field angle information, the convergence angle information, and the inter-axial information, the stereoscopic image made up of a left eye image and a right eye image, wherein:
the parallax converter sets a first parallax amount of a subject at a specific location on a basis of the horizontal field angle information, the convergence angle information, and the inter-axial information, sets a parallax coefficient on a basis of the first parallax amount and a second parallax amount allowed for the subject in the specific location, and sets an amount of parallax in the stereoscopic image to be less than or equal to the second parallax amount on a basis of the parallax coefficient.

6. The stereoscopic image capture device according to claim 5, wherein
the parallax coefficient is a ratio of the second parallax amount with respect to the first parallax amount.

7. The stereoscopic image capture device according to claim 5, wherein
the parallax converter sets the amount of parallax of the stereoscopic image to be less than or equal to the second parallax amount by detecting a first contour of the left eye image and a second contour of the right eye image, and converting a third parallax amount between the first contour and the second contour so that the third parallax amount is an inverse multiple of the parallax coefficient.

8. The stereoscopic image capture device according to claim 5, wherein
the first parallax amount and the second parallax amount are set for a subject located at an infinite distance.

9. A stereoscopic image capture device, comprising:
a left eye image capture component including a first zoom lens and configured to capture a left eye image;
a right eye image capture component including a second zoom lens and configured to capture a right eye image;
a field angle controller configured to control a field angle of the first zoom lens and a field angle of the second zoom lens and output horizontal field angle information, the horizontal field angle information including the field angles of the first zoom lens and second zoom lens;
a convergence angle controller configured to control a convergence angle of the left eye image capture component and a convergence angle of the right eye image capture component, and output convergence angle information, the convergence angle information including the convergence angles of the left eye image capture component and the right eye image capture component;
a parallax converter configured to convert an amount of parallax of a stereoscopic image on a basis of the horizontal field angle information, the convergence angle information, and inter-axial information, the inter-axial information including a base line length between the left eye image capture component and the right eye image capture component in a state in which the base line length is fixed, the stereoscopic image made up of a left eye image and a right eye image, wherein
the parallax converter sets a first parallax amount of a subject at a specific location on a basis of the horizontal field angle information, the convergence angle information, and the inter-axial information, sets a parallax coefficient on a basis of the first parallax amount and a second parallax amount allowed for the subject in the specific location, and sets the amount of parallax in the stereoscopic image to be less than or equal to the second parallax amount on a basis of the parallax coefficient.

10. The stereoscopic image capture device according to claim 9, wherein
the parallax coefficient is a ratio of the second parallax amount with respect to the first parallax amount.

11. The stereoscopic image capture device according to claim 9, wherein
the parallax converter sets the amount of parallax of the stereoscopic image to be less than or equal to the second parallax amount by detecting a first contour of the left eye image and a second contour of the right eye image, and converting a third parallax amount between the first contour and the second contour so that this third parallax amount is an inverse multiple of the parallax coefficient.

12. The stereoscopic image capture device according to claim 9, wherein
the first parallax amount and the second parallax amount are set for a subject located at an infinite distance
